(19) United States
(12) Patent Application Publication
(10) Pub. No.: US 2026/0188914 A1
(43) Pub. Date: Jul. 2, 2026

(54) DIELECTRIC-LOADED MULTIPLE-INPUT-MULTIPLE-OUTPUT TUNABLE ANTENNA

(71) Applicant: INSTITUT NATIONAL DE LA RECHERCHE SCIENTIFIQUE, Quebec (CA)

(72) Inventors: Amjad IQBAL, Montreal (CA); Tayeb A. DENIDNI, Brossard (CA)

(21) Appl. No.: 19/123,875

(22) PCT Filed: Oct. 27, 2023
(86) PCT No.: PCT/CA2023/051434

§ 371 Date: Apr. 24, 2025

Related U.S. Application Data
(60) Provisional application No. 63/381,425, filed on Oct. 28, 2022.

(51) Int. Cl. H01Q 21/06

(52) U.S. Cl. CPC H01Q 21/065

(57) ABSTRACT

There is disclosed a data transmission apparatus and tuned Multiple-Input-Multiple Output (MIMO) antenna comprising a dielectric substrate and an array of antenna elements arranged adjacent one another on a first side of the substrate. Each of the antenna elements comprises a patch antenna and a dielectric material positioned at a corner of the patch antenna having a selected permittivity. The resonant frequency of the antenna element is tuned through the selected permittivity of the dielectric material. In a particular embodiment the dielectric material comprises a ceramic.

### FIELD OF THE INVENTION

The present invention relates to a multiple-input-multiple output (MIMO) antenna system, and particularly to a tunable dielectric-loaded MIMO antenna system.

### BACKGROUND TO THE INVENTION

In recent years, much progress has been observed in wireless communication products. In fact, next-generation wireless technologies require high-data-rates, which is possible with a multiple-input-multiple-output (MIMO) configuration. In addition, the frequency spectrum remains a costly asset which must be shared among future generation wireless technologies. At the same time, radiofrequency (RF) circuits should have the ability to support multi-standard wireless communication. Hence, there is an immense need for tunable RF circuits, including MIMO antennas.

Systems using MIMO tunable antennas are found in various fields. For example, in wireless communication networks, these systems are used in cellular base stations, Wi-Fi routers, and other wireless devices to enhance the network capacity and performance. In the automotive industry, MIMO tunable antennas are employed in advanced driver-assistance systems (ADAS) and vehicle-to-vehicle (V2V) communication to improve connectivity and reliability.

The majority of prior art tunable/reconfigurable MIMO antennas take advantage of varactor diodes or pin diodes for tunability/reconfigurability. By changing between the ON and OFF states of the pin diodes using bias voltage, frequency reconfigurability has been achieved. Similarly, changing the bias voltage across the varactor diode has been used for continuous frequency tuning. This configuration requires a complex biasing circuit and non-linear and lossy varactor/pin diodes, making the system complex and lossy. In addition, it consumes more power.

In the next-generation wireless communication devices, the reliability and high-data-rates requirements are exponentially increased. High-data-rates and reliability of data are necessary in high-quality audio/video calls, live streaming, online video games and many more. These applications require high data rates which are possible using a wide frequency bandwidth. However, an extended bandwidth may cause interference with other communication devices and consume more spectrum. Hence, a multiple-input-multiple-output (MIMO) configuration is considered as a best alternative for high-data-rates wireless communication devices. With this configuration, high-data-rates are achieved without excessive frequency and power resources. Moreover, a multi-standard device needs an antenna with multiple resonant frequencies to cover many applications. However, a static antenna utilizes one frequency band, but the other bands may use frequency spectrum without any operation and may cause interference. Thus, frequency-reconfigurable/tunable antennas are required to avoid interferences and usage of extra frequency spectrum.

Reconfigurable antennas can change their attributes, such as the resonant frequency, impedance bandwidth, radiation pattern and polarization as per requirements. A frequency-reconfigurable antenna is important as it can enhance the spectrum utilization by activating different resonant bands for different applications in the same antenna. Hence, a single antenna can be used for a wide range of applications by just switching the resonant band. So far, different methods have been adopted to reconfigure the resonant frequency. PIN-diode based frequency reconfigurable antennas have been reported. With this configuration eight unique frequency bands are achieved using four different modes. A multi-port and multi-band antenna has also been proposed using voltage-controlled varactor diodes. A dual-port reconfigurable antenna using varactor diodes is also known which can operate between 1.3 and 1.8 GHZ. Additionally, a four-element MIMO antenna system with reconfigurable frequency bands is known. The reconfiguration in the frequency band has been achieved using varactor diodes. Similarly, a frequency reconfigurable MIMO using sensing antennas has been proposed using voltage-controlled PIN diodes. Similarly, many other frequency reconfigurable MIMO antennas have been reported using PIN or varactor diodes. These MIMO antenna systems show reasonable gain, impedance matching and frequency-reconfigurability. However, they are large and require lossy and non-linear electronic components for operation. Consequently, these systems are large, complex, lossy and power consuming. To resolve the current limitations, we have proposed a novel way to reconfigure the frequency bands. The proposed tuning technique does not require complex biasing circuitry, direct current (DC) source, and non-linear lossy diodes which make the system cost- and power-efficient.

### SUMMARY OF THE INVENTION

In order to address the above and other drawbacks there is provided a tuned Multiple-Input-Multiple Output (MIMO) antenna comprising a dielectric substrate and an array of antenna elements arranged adjacent one another on a first side of the substrate. Each of the antenna elements comprises a patch antenna and a dielectric material positioned at a corner of the patch antenna and having a selected permittivity. The resonant frequency of the antenna element is tuned through the selected permittivity of the dielectric material.

There is also provided a data transmission apparatus comprising a tuned Multiple-Input-Multiple Output (MIMO) antenna, a memory, a processor coupled to the memory programmed with executable instructions, the instructions comprising a transmitter interface for transmission of at least one data stream via the tuned MIMO antenna, wherein the tuned MIMO antenna comprises an array of antenna elements arranged adjacent one another on a first side of a substrate. Each of the antenna elements comprises a patch antenna. Each of the antenna elements comprises a signal port. The signal port receives the data stream from the processor. Each of the antenna elements comprises a selected one of a at least one dielectric material positioned at the corner of the patch antenna. Each of the at least one dielectric material has a different permittivity. The resonant frequency of each of the antenna elements is tuned independent of any of the other antenna elements through the different permittivity of the selected dielectric material.

Additionally, there is provided a method for tuning a Multiple-Input-Multiple Output (MIMO) antenna comprising at least one flat metallic patch mounted on a first surface of a dielectric substrate and a flat ground plane mounted on a second surface of the dielectric opposite the flat metallic patch. The method comprises machining an aperture through at least a portion of the flat metallic patch, the dielectric substrate and the ground plane wherein the aperture is aligned with a corner of the flat metallic patch, selecting a dielectric material having a permittivity, and filing the aperture with the selected dielectric material.

### BRIEF DESCRIPTION OF THE DRAWINGS

FIG. 1 provides a block diagram of a data transmission system in accordance with an illustrative embodiment of the present invention;

FIG. 2 provides a block diagram of a data transmission apparatus in accordance with an illustrative embodiment of the present invention;

FIG. 3A provides a top plan view of a Dielectric-Loaded MIMO Tunable Antenna in accordance with an illustrative embodiment of the present invention;

FIG. 3B provides a bottom plan view of a Dielectric-Loaded MIMO Tunable Antenna in accordance with an illustrative embodiment of the present invention;

FIG. 4 provides simulated and measured radiation patterns of a Dielectric-Loaded MIMO Tunable Antenna in accordance with an illustrative embodiment of the present invention; and

FIG. 5 provides S-Parameters of a Dielectric-Loaded MIMO Tunable Antenna with dielectric permittivity of respectively εᵣ=0, 2.2, 10.2 and 37 and in accordance with illustrative embodiments of the present invention.

### DETAILED DESCRIPTION OF THE ILLUSTRATIVE EMBODIMENTS

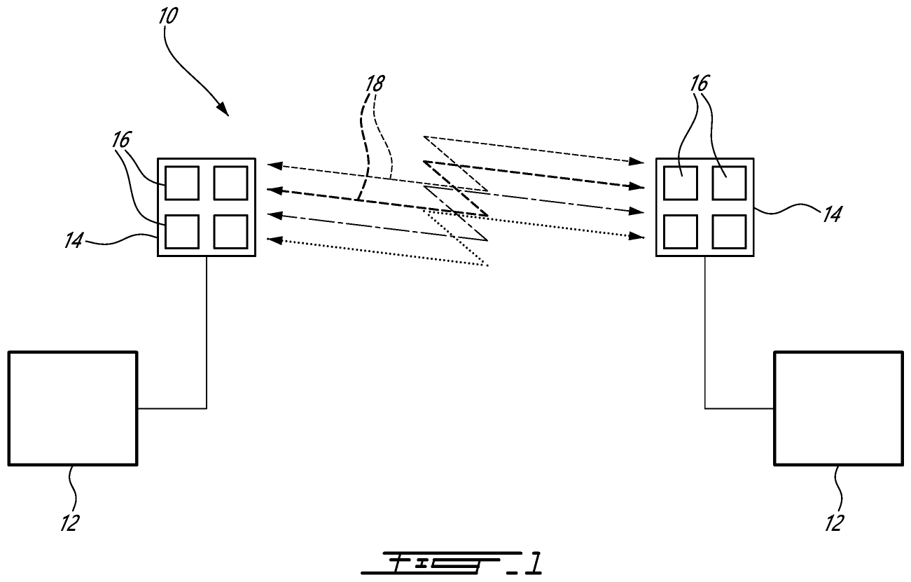

Referring now to FIG. 1, a dielectric-loaded MIMO tunable antenna system 10 will be described. The system comprises a plurality of transmitter/receivers 12 each comprising a dielectric-loaded MIMO tunable antenna array 14. As will be discussed in more detail below, the antenna array 14 comprises multiple antennas 16 which are used at both the transmitter and receiver ends allowing the system to take advantage of spatial diversity and multipath propagation. By using multiple antennas 16, it is possible to transmit and receive multiple data streams simultaneously over the same frequency band. This results in increased spectral efficiency, improved link reliability, and enhanced overall system performance. Additionally, as will also be described in more detail below, the antennas 16 are independently tunable. This allows for, inter alia, increased data rates by supporting the transmission of multiple streams 18 of data simultaneously. This is particularly useful in applications that require high-bandwidth communication, such as video streaming or large file transfers. Additionally, the provision of multiple antennas 16 enhances system robustness and reliability. Indeed, by exploiting spatial diversity, the system can overcome the detrimental effects of fading and interference, resulting in improved signal quality and coverage. Furthermore, the provision of tunable antennas enables the system 10 to adapt to different operating conditions and frequency bands. This flexibility is particularly valuable in scenarios where the available spectrum is limited or subject to regulatory restrictions.

Still referring to FIG. 1, the antennas 16, which are strategically placed on the transmitter/receiver 12, can be arranged in various configurations, such as a 2×2, 3×3, or 4×4 arrangement, depending on the desired system characteristics. The tunable aspect of the antennas 16 refers to the ability to adjust their operating frequency and radiation properties. As will be discussed in more detail below, this is achieved by incorporating tunable elements into the antenna design. These elements allow for dynamic control of the antenna's resonant frequency, impedance, and radiation pattern, thereby optimizing its performance for different operating conditions.

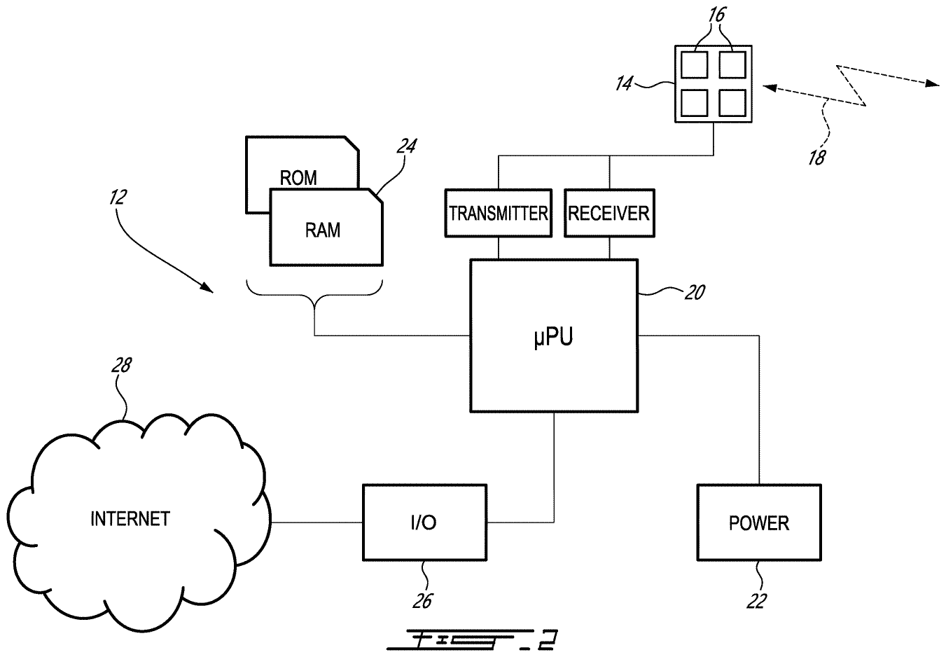

Referring now to FIG. 2, in an embodiment the transmitter/receiver 12 comprises a processor 20, such as microcontroller or microprocessor or the like, powered by a power supply 22 and comprising signal processing such as algorithms in the form of processor executable instructions and other data held in a memory 24, such ROM or RAM or the like. The signal processing algorithms efficiently handle the streams 18 of data to be transmitted or received by the antenna array 14. In particular, during transmission the signal processing maps the data streams to the different antennas 16, and may include techniques such as spatial multiplexing allows for simultaneous transmission of multiple data streams or beamforming which can be used to focus the transmitted stream in a desired direction to improve signal quality. Similar, during reception the signal processing detects and separates the different received streams or signals. In this regard, the signal processing may exploit the spatial diversity provided by the multiple antennas to mitigate the effects of fading and interference, resulting in improved signal quality and increased data rates. Typically, the signal processing can provide the following:
Spatial Multiplexing: The data to be transmitted is divided into multiple streams, each of which is assigned to a different transmit antenna 16. This allows for parallel transmission of data streams 18.
Precoding: Precoding techniques are applied to the data streams to optimize the transmission performance. These techniques involve manipulating the data streams based on Channel State Information (CSI) to minimize interference and maximize the signal quality at the receiver.
Channel Encoding: The data streams 18 are encoded using error correction codes to enhance reliability and error resilience during transmission. This encoding process adds redundancy to the data, enabling the receiver to detect and correct errors.
Transmission: The encoded data streams are transmitted simultaneously through the multiple transmit antennas 16. Each antenna 16 transmits its own data stream, taking advantage of the spatial diversity offered by the multiple antennas 16.
Reception: At the receiving end, multiple antennas 16 receive the transmitted signals. The received signals are processed to separate the individual data streams transmitted from different antennas.
Decoding: The received data streams 18 are decoded using channel decoding techniques to recover the original data. The decoding process compensates for the errors introduced during transmission.

Still referring to FIG. 2, the transmitter/receiver 12 may additionally include an external interface 26 for accessing the Internet 28 and such that received streams 18 of data may be relayed to external devices or the like. In this regard, and as will be understood by a person of ordinary skill in the art, the microprocessor 20, using additional microprocessor readable instructions held in the memory 24, will provide appropriate conversion and communication functions such that the streams 18 of data may be transmitted to one or more external devices (not shown).

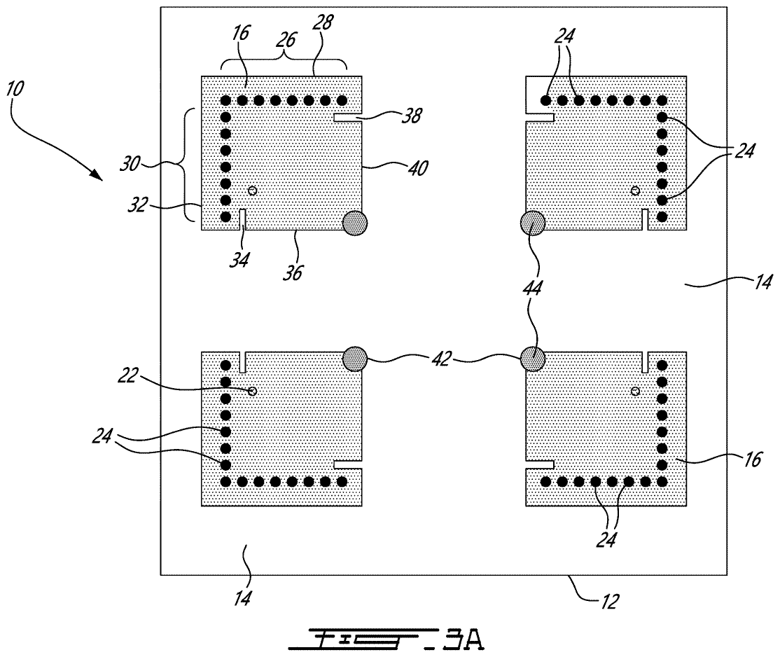

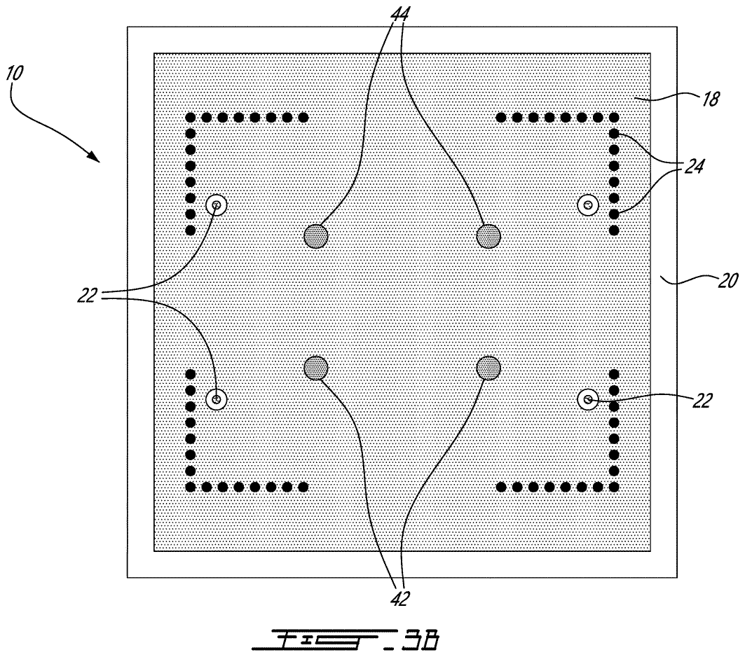

Referring now to FIG. 3A, the dielectric-loaded MIMO tunable antenna array 14 will now be described. As discussed above, the tunable antenna array 14 comprises two or more antennas 16. The multiple antennas 16 are illustratively combined in a single physical package and is designed for use in IEEE 802.11n/ac Wi-Fi networks. The antennas 16 are housed inside a single antenna enclosure (not shown), so from the outside the antenna array 14 looks like a single antenna. As discussed above, by using multiple antennas 16, data throughput, speed and range are increased compared to a single antenna using the same radio transmit power, such as the older 802.11B/G standard. The antenna array 14 improves link reliability and experiences less fading than a single antenna system. Additionally, as also discussed above, by transmitting multiple data streams 18 at the same time, the data transmission capability of the overall system may be increased.

Still referring to FIG. 3A in addition to FIG. 2, The antenna array 14 illustratively comprises a substantially square dielectric substrate 30 onto a first surface 32 of which a plurality of illustratively four (4) metallic antennae 16 are formed, for example using conventional etching techniques and a printed circuit board (PCB) as well known in the art. Each antenna 16 comprises a square patch antenna fabricated from copper and arranged flat on the first surface 32 of the dielectric substrate 30. The four (4) square patch antennae 16 are illustratively arranged adjacent one another and side by side in a 2×2 array configuration with each of the antennae 16 arranged at a respective corner of a square dimensioned by the 2×2 array 14 of antennae 16.

Referring to FIG. 3B, a metallic ground plane 34 is formed on a second surface 36 of the dielectric substrate 30 opposite the first surface 32. As with the antenna 16, the metallic ground plane 34 can be formed of copper using conventional etching techniques as well known in the art. Referring to FIG. 3A in addition to FIG. 3B, each patch antenna 16 comprises a signal port 38 via which signals can be independently transmitted or received, for example via a respective coaxial cable or the like (not shown) each of which is interconnected with the processor 20. Additionally, a plurality of vias 40 interconnect the patch antenna 16 with the ground plane 34. A first row 42 of vias 40, equally spaced, is arranged along a first outer edge 44 of the patch antenna 16 and a second row 46 of vias 40, also equally spaced and at right angles to the first row 42 of vias 40 is arranged along a second outer edge 48 of the patch antenna 16. The spaced rows 42, 46 of vias 40 act as waveguides to ensure correct propagation of signals between the signal port 38 and antenna 16.

Still referring to FIGS. 3A and 3B, each patch antenna 16 comprises a first slot 50 in a third inner edge 52 of the patch antenna 16 and a second slot 54 in a third inner edge 56 of the patch antenna 16. Additionally, an aperture 58 such as a cylindrical bore is provided in the substrate 30 between the first surface 32 and the second surface 36. The aperture 58 is filled with a dielectric material 60 having a selected permittivity, preferably manufactured from a ceramic material such as oxides such as alumina, silica and the like. In a particular embodiment a dielectric material manufactured as cylindrical ceramic rod and having a selected diameter such that the material fits snugly within a bore like aperture 58 is provided. Alternatively, the dielectric rods can be manufactured from PCBs such as FR-4 or Rogers.

Still referring to FIGS. 3A and 3B, in a particular embodiment each patch antenna 16 is 11.25 mm×11.25 mm. Additionally, the vias 40 are circa 0.8 mm in diameter. The vias 40 are evenly spaced according to a pitch of 1.22 mm such that the length of a given row 42, 46 of vias 40 is 8.54 mm. The bore 58 is circa 2 mm in diameter and the metallic ground plane 34 is 37.5 mm×37.5 mm. The first slots 50 are of 0.5 mm width and 1.5 mm in length and the second slots 54 are of 0.5 mm width and 2 mm in length.

Still referring to FIGS. 3A and 3B, the antennae 16 can illustratively be tuned to selected frequencies by loading the bores 58 with a ceramic dielectric material 60 cut from rods of different permittivity thereby doing away with the need for a complex biasing circuitry, direct current (DC) source and non-linear lossy diodes, thereby simplifying tunable antenna 16 while providing for a more compact, power efficient and cost efficient solution. Additionally, or alternatively, tuning of the antennae 16 to selected frequencies can be carried out by modifying the geometry of the ceramic dielectric material 60 accordingly.

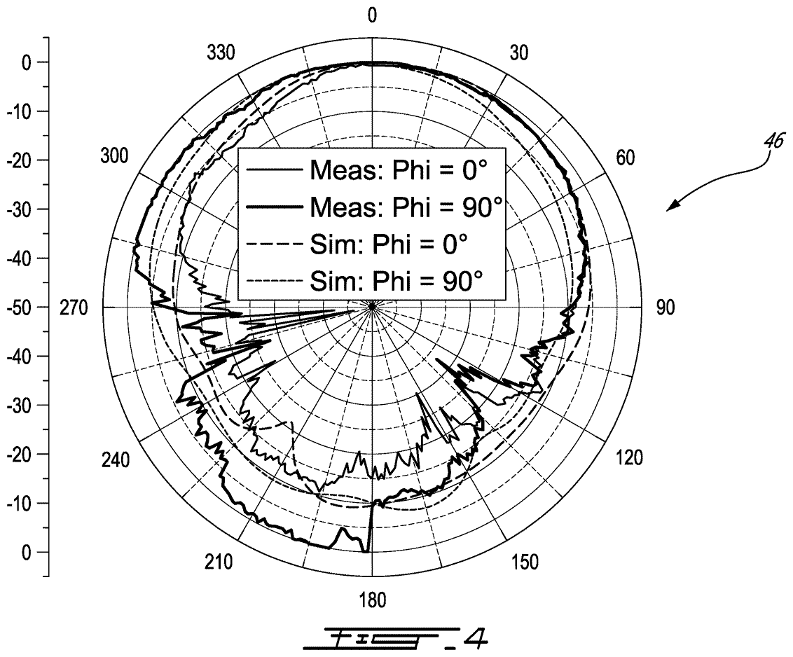

Referring now to FIG. 4, simulated and measured radiation patterns 62 of an antenna according to the present is provided.

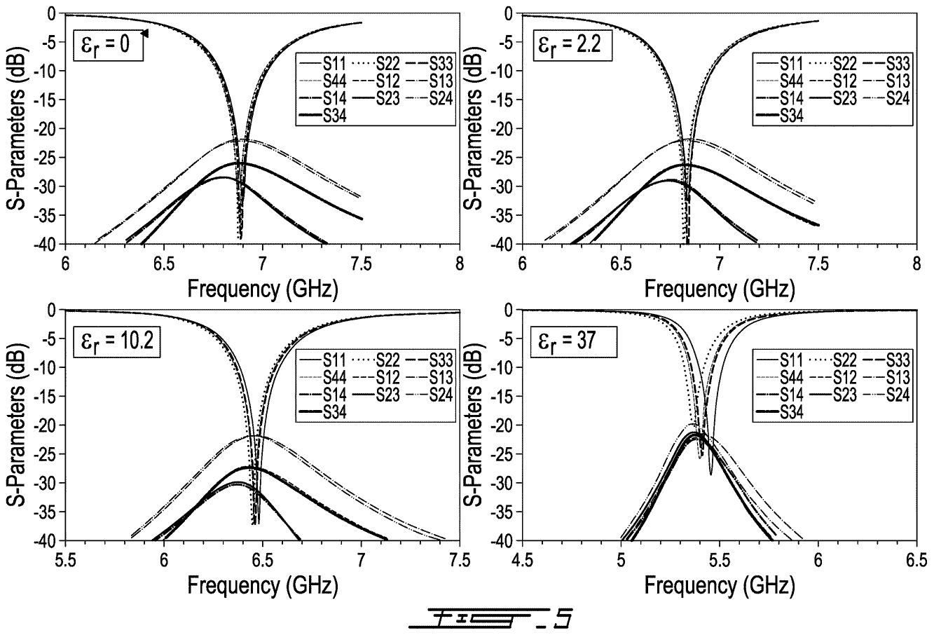

Referring now to FIG. 5, S-parameters were measured for dielectric rods of different permittivity. As will now be apparent to a person of ordinary skill in the art, the resonant frequency of an antenna is lowered as the permittivity of a dielectric material 60 increases. More specifically, the resonant frequency of the antenna is 6.89 GHz when the permittivity of the dielectric material 60 is 0. The resonant frequency shifts to 6.83 GHz when the permittivity of the dielectric material 60 is 2.2. Moreover, the antenna resonant frequency of the antenna is 6.46 and 5.4 GHz for a dielectric rod 44 of 10.2 and 37, respectively. Of note is that the resonant frequency of the antenna 16 has an inverse relationship with the permittivity of the dielectric material 60. Additionally, the tuning range of an antenna can be enhanced by using a dielectric material 60 of high permittivity. Furthermore, the isolation between the elements is always more than 22 dB, which is sufficient for uncorrelated channels.

Although the present invention has been described hereinabove by way of specific embodiments thereof, it can be modified, without departing from the spirit and nature of the subject invention as defined in the appended claims.

1. A tuned Multiple-Input-Multiple Output (MIMO) antenna comprising:
a dielectric substrate; and
an array of antenna elements arranged adjacent one another on a first side of the substrate, wherein each of the antenna elements comprises:
a patch antenna; and
a dielectric material positioned at a corner of the patch antenna and having a selected permittivity;
wherein a resonant frequency of the antenna element is tuned through the selected permittivity of the dielectric material.

2. The tuned MIMO antenna of claim 1, wherein each of the antenna elements comprises a signal port.

3. The tuned MIMO antenna of claim 1, wherein each of the antenna elements comprises:
a ground plane arranged on a second surface of the substrate, wherein the ground plane preferably comprises a copper ground plane;
a first row of vias arranged along a first outer edge of the patch antenna, each of the first row of vias interconnecting the patch antenna with the ground plane;
a second row of vias arranged at right angles to the first row along a second outer edge of the patch antenna, each of the second row of vias interconnecting the patch antenna with the ground plane, wherein the first row of vias and the second row of vias are preferably spaced;
a first slot in a third inner edge of the patch antenna between the first row of vias and a fourth edge of the patch antenna opposite the first edge;
a second slot in the fourth inner edge of the patch antenna between the second row of vias and the third edge of the patch antenna opposite the second edge;
an aperture between the first surface and the second surface of the dielectric substrate at an intersection of the third edge and the fourth edge;
wherein the dielectric material is positioned within the aperture, wherein the aperture preferably comprises a bore and wherein the dielectric preferably comprises a disk of the dielectric material having the selected permittivity and sized to fit snugly within the bore.

4. The tuned MIMO antenna of claim 1, wherein the dielectric material comprises a ceramic, preferably the ceramic comprising an oxide and more preferably the oxide comprising one of alumina and silica.

5.-6. (canceled)

7. The tuned MIMO antenna of claim 1, wherein the dielectric material comprises a PCB, preferably the PCB comprising one of FR-4 and Rogers and more preferably the oxide comprising one of alumina and silica.

8.-9. (canceled)

10. The tuned MIMO antenna of claim 1, wherein the array of antenna elements is arranged as a 2×2 array of antenna elements.

11. The tuned MIMO antenna of claim 1, wherein the patch antenna is square.

12. The tuned MIMO antenna of claim 1, wherein the patch antenna comprises a copper patch antenna.

13.-14. (canceled)

15. A data transmission apparatus comprising:
a tuned Multiple-Input-Multiple Output (MIMO) antenna;
a memory;
a processor coupled to the memory programmed with executable instructions, the instructions comprising a transmitter interface for transmission of at least one data stream via the tuned MIMO antenna;
wherein the tuned MIMO antenna comprises an array of antenna elements arranged adjacent one another on a first side of a substrate;
wherein each of the antenna elements comprises a patch antenna;
wherein each of the antenna elements comprises a signal port;
wherein the signal port receives the data stream from the processor;
wherein each of the antenna elements comprises a selected one of a at least one dielectric material positioned at a corner of the patch antenna;
wherein each of the at least one dielectric material has a different permittivity;
wherein a resonant frequency of each of the antenna elements is tuned independent of any of the other antenna elements through the different permittivity of the selected dielectric material.

16. The data transmission apparatus of claim 15, wherein the executable instructions further comprise a receiver interface for reception of at least one data stream via the tuned antenna.

17. The data transmission apparatus of claim 15, wherein each of the antenna elements comprises:
a ground plane arranged on a second surface of the substrate;
a first row of vias arranged along a first outer edge of the patch antenna, each of the first row of vias interconnecting the patch antenna with the ground plane;
a second row of vias arranged at right angles to the first row along a second outer edge of the patch antenna, each of the second row of vias interconnecting the patch antenna with the ground plane;
a first slot in a third inner edge of the patch antenna between the first row of vias and a fourth edge of the patch antenna opposite the first edge;
a second slot in the fourth inner edge of the patch antenna between the second row of vias and the third edge of the patch antenna opposite the second edge, wherein the first row of vias and the second row of vias are preferably spaced;
an aperture between the first surface and the second surface of the dielectric substrate at an intersection of the third edge and the fourth edge; wherein the dielectric material is positioned within the aperture.

18. The data transmission apparatus of claim 15, wherein the at least one dielectric material comprises a ceramic.

19. The data transmission apparatus of claim 15, wherein the array of antenna elements is arranged as a 2×2 array of antenna elements.

20. The data transmission apparatus of claim 15, wherein the patch antenna is square.

21. The tunable antenna of claim 17, wherein the aperture comprises a bore and further wherein the dielectric comprises a disk of the dielectric material having the selected permittivity and sized to fit snugly within the bore.

22. (canceled)

23. A method for tuning a Multiple-Input-Multiple Output (MIMO) antenna comprising at least one flat metallic patch mounted on a first surface of a dielectric substrate and a flat ground plane mounted on a second surface of the dielectric opposite the flat metallic patch, the method comprising:
machining an aperture through at least portion of the at least one flat metallic patch, the dielectric substrate and the ground plane wherein the aperture is aligned with a corner of the flat metallic patch;
selecting a dielectric material having a permittivity; and
filing the aperture with the selected dielectric material.

24. The method of claim 23, wherein the dielectric material comprises a ceramic.

25. The method of claim 23, further comprising arranging an array of four flat metallic patches in a 2×2 configuration and wherein each of the four flat metallic patches is independently tuned.

26. The method of claim 23, wherein the flat metallic patch is square.

27. The method of claim 23, wherein the machined aperture comprises a bore and further wherein the selected dielectric comprises a disk of the dielectric material having the selected permittivity and further comprising sizing the disk to fit snugly within the bore.
